(19) United States
(12) Patent Application Publication
(10) Pub. No.: US 2019/0088000 A1
(43) Pub. Date: Mar. 21, 2019

(54) IMAGE PROCESSING SYSTEM AND METHOD

(71) Applicant: Acer Incorporated, New Taipei City (TW)

(72) Inventors: Chih-Wen HUANG, New Taipei City (TW); Chao-Kuang YANG, New Taipei City (TW)

(21) Appl. No.: 15/981,045

(22) Filed: May 16, 2018

(30) Foreign Application Priority Data
Sep. 20, 2017 (TW) 106132230

(51) Int. Cl. G06T 15/00; G06T 1/60; H04N 13/344

(52) U.S. Cl. CPC G06T 15/005; H04N 13/344; G06T 1/60

(57) ABSTRACT

An image processing system is provided in the invention. The image processing system includes a head-mounted display and an image processing device. The image processing device includes a processor. The processor transmits helmet information corresponding to the head-mounted display to a User Mode Driver. According to the helmet information and a first framebuffer which is obtained from a Kernel Mode Driver, the User Mode Driver generates a second framebuffer. The processor directly generates display information according to the second framebuffer, and the head-mounted display receives the display information and displays a picture according to the display information.

### CROSS REFERENCE TO RELATED APPLICATIONS

This Application claims priority of TW Patent Application No. 106132230 filed on Sep. 20, 2017, the entirety of which is incorporated by reference herein.

### BACKGROUND OF THE INVENTION

### Field of the Invention

The invention generally relates to image processing technology, and more particularly, to image processing technology used for displaying content generated using the Direct3D and OpenGL graphics application programming interfaces (APIs) through a virtual reality (VR) head-mounted display.

### Description of the Related Art

With the advances being made in science and technology, image display technology is progressing gradually. Virtual Reality (VR) is a display technology that uses computer science to simulate a virtual three-dimensional (3D) space. Users can wear dedicated wearable devices (e.g. a helmet, eyeglasses) to have a realistic experience in an immersive virtual environment through their vision.

However, content intended for display on a conventional VR helmet is being developed on a development platform which was self-developed by the developer. Thus, these conventional VR helmets are not capable of directly displaying Direct3D and OpenGL content. However, most 3D software and 3D games are being developed based on the Direct3D and OpenGL engines. Therefore, if VR helmets are not capable of directly displaying Direct3D and OpenGL content, the content displayed by the VR helmets will be limited.

### BRIEF SUMMARY OF THE INVENTION

An image processing system and method, in which Direct3D and OpenGL content can be directly displayed by a virtual reality (VR) head-mounted display, are provided to overcome the problems mentioned above.

An embodiment of the invention provides image processing system. The image processing system comprises a head-mounted display and an image processing device. The image processing device comprises a processor. The processor transmits helmet information corresponding to the head-mounted display to a User Mode Driver. According to the helmet information and a first framebuffer which is obtained from a Kernel Mode Driver, the User Mode Driver generates a second framebuffer. The processor directly generates display information according to the second framebuffer, and the head-mounted display receives the display information and displays a picture according to the display information.

In some embodiments of the invention, the helmet information comprises the resolution of the head-mounted display.

In some embodiments of the invention, the first framebuffer is generated using the Direct3D and OpenGL technologies.

In some embodiments of the invention, the User Mode Driver transforms the first framebuffer into the second framebuffer which is appropriate to the resolution of the head-mounted display according to the resolution and the first framebuffer.

In some embodiments of the invention, the processor directly generates a left-eye picture and a right-eye picture which correspond to the head-mounted display according to the second framebuffer and pupil distance information of the user of the head-mounted display.

An embodiment of the invention provides an image processing method. The image processing method comprises the steps of transmitting helmet information corresponding to a head-mounted display to a User Mode Driver, according to the helmet information and a first framebuffer which is obtained from a Kernel Mode Driver, generating a second framebuffer; directly generating display information according to the second framebuffer; and displaying a picture according to the display information.

Other aspects and features of the invention will become apparent to those with ordinary skill in the art upon review of the following descriptions of specific embodiments of image processing systems and methods.

### BRIEF DESCRIPTION OF THE DRAWINGS

The invention will become more fully understood by referring to the following detailed description with reference to the accompanying drawings, wherein:

FIG. 1 is a block diagram of an image processing system 100 according to an embodiment of the invention;

FIG. 2 is a schematic diagram illustrating architecture of the display driving operations according to an embodiment of the invention; and

FIG. 3 is a flow chart 300 illustrating an image processing method according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

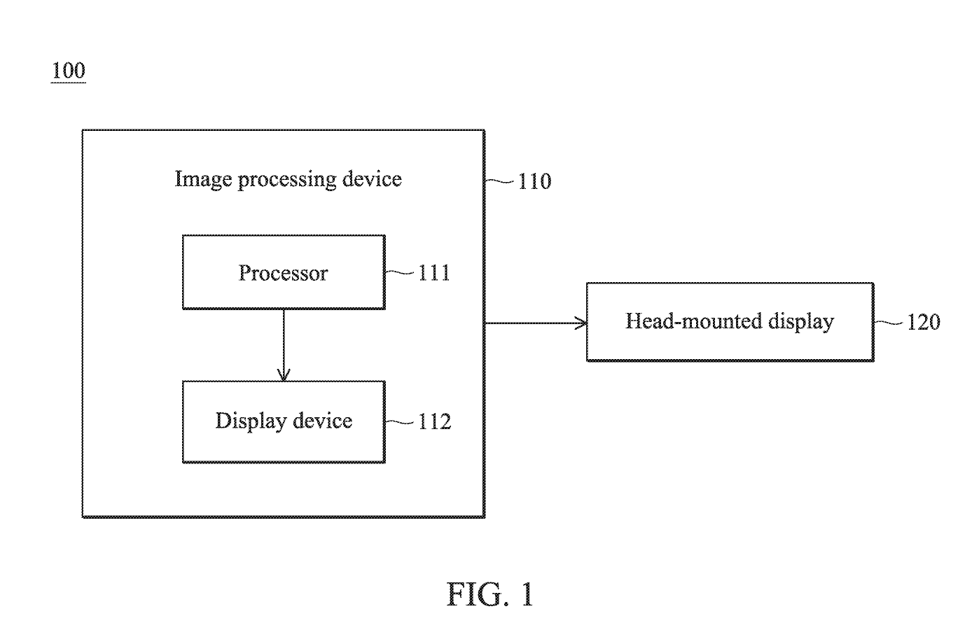

FIG. 1 is a block diagram of an image processing system 100 according to an embodiment of the invention. As shown in FIG. 1, the image processing system 100 may comprise an image processing device 110 and a head-mounted display (HMD) 120. In an embodiment of the invention the image processing device 110 may comprise a processor 111 and a display device 112. FIG. 1 presents a simplified block diagram in which only the elements relevant to the invention are shown. However, the invention should not be limited to what is shown in FIG. 1. The image processing device 110 may further comprise other elements.

In the embodiments of the invention, the image processing device 110 may be a notebook, a smart phone or a tablet, but the invention should not be limited thereto. In an embodiment of the invention, the display device 112 may be a general display device, e.g. a screen of a notebook, a screen of a smart phone or a display connected to a desktop computer, but the invention should not be limited thereto. In an embodiment of the invention, the head-mounted display 120 may be a Virtual Reality (VR) helmet. When the user wants to see the VR content, the head-mounted display 120 may be coupled to the image processing device 110 to make it so the user can see the VR content through the head-mounted display 120.

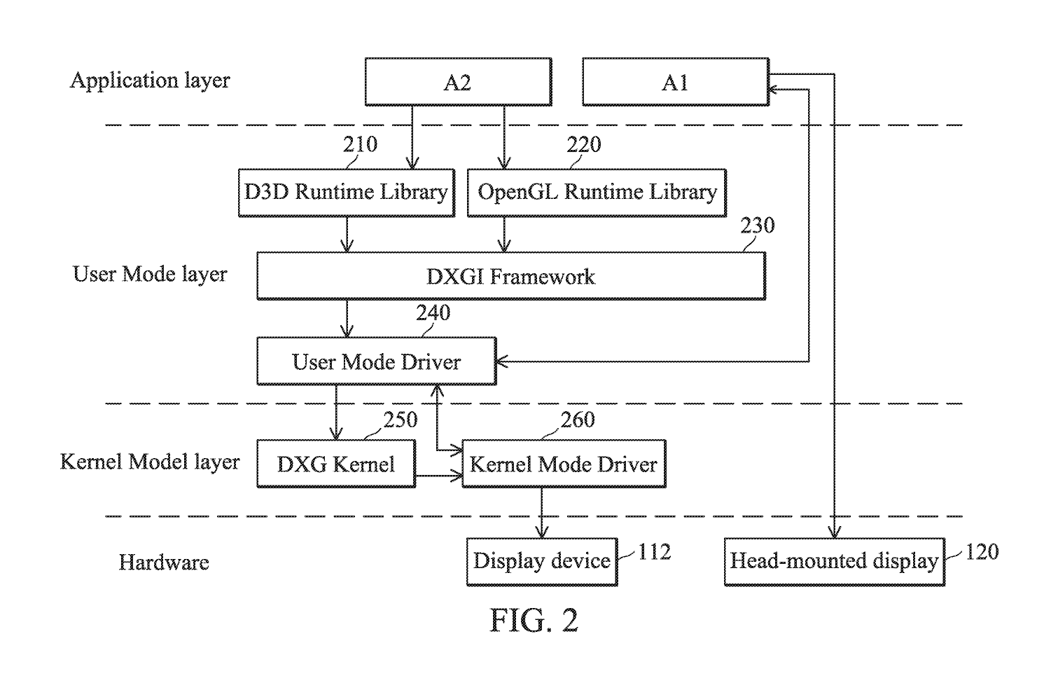

FIG. 2 is a schematic diagram illustrating architecture of the display driving operations according to an embodiment of the invention. In the embodiments of the invention, the processor 111 may perform the related display driving operations and calculations of the architecture shown in FIG. 2. As shown in FIG. 2, the architecture of the display driving operations may be divided in to an application layer, a User Mode layer and a Kernel Model layer. It should be noted that the schematic diagram of FIG. 2 is only used to conveniently illustrate the embodiments of the invention, but the invention should not be limited thereto.

According to an embodiment of the invention, the application layer may comprise application programs, e.g. application program A1 and application program A2 shown in FIG. 2.

According to an embodiment of the invention, the User Mode layer may comprise a Direct3D (D3D) Runtime Library 210, an OpenGL Runtime Library 220, a DirectX Graphics Infrastructure (DXGI) Framework 230, and a User Mode Driver 240.

According to an embodiment of the invention, the Kernel Model layer may comprise a DirectX Kernel (DXG Kernel) 250 and a Kernel Mode Driver 260.

According to an embodiment of the invention, when the picture, which is displayed on the display device 112 and generated using the D3D and OpenGL technologies, needs to be displayed on the head-mounted display 120, the processor 111 may run an application program A1 (e.g. a VR HMD display application) to transmit the helmet information of the head-mounted display 120 to the User Mode Driver 240. As shown in FIG. 2, the picture, which is displayed on the display device 112 and generated using the D3D and OpenGL technologies, may be generated after the processor runs an application program A2.

According to an embodiment of the invention, the helmet information may comprise the resolution of the head-mounted display 120. In an embodiment of the invention, the User Mode Driver 240 may comprise a User-mode display driver, an OpenGL installable client driver and an application programming interface (API) which was developed for the operations of the invention.

According to an embodiment of the invention, after the User Mode Driver 240 has received the helmet information of the head-mounted display 120, the User Mode Driver 240 may directly obtain the framebuffer F1 of the picture, which is displayed on the display device 112 and generated using the D3D and OpenGL technologies, from the Kernel Mode Driver 260. That is to say, in the embodiment, the User Mode Driver 240 does not need to obtain the framebuffer F1 of the picture, which is displayed on the display device 112 and generated using the D3D and OpenGL technologies, from the DirectX Kernel 250 first. In conventional display driving operation, the User Mode Driver 240 must communicate with the Kernel Mode Driver 260 through the DirectX Kernel 250. For example, the User Mode Driver 240 must transmit instructions to the Kernel Mode Driver 260 through the DirectX Kernel 250 before the display device 112 can display the picture corresponding to the D3D and OpenGL content. In the other words, in the embodiment, the parts of the functions of the DirectX Kernel 250 are transferred to the Kernel Mode Driver 260. Therefore, when the D3D and OpenGL content will be played on the head-mounted display 120, the User Mode Driver 240 may directly communicate with the User Mode Driver 240 without through the DirectX Kernel 250 to reduce the transmission time of the signals and instructions. Therefore, there is less picture-latency, which is normally generated because of too many transmissions of instructions and signals.

According to an embodiment of the invention, after the User Mode Driver 240 has obtained the framebuffer F1 of the picture, which is displayed on the display device 112 and generated using the D3D and OpenGL technologies, from the Kernel Mode Driver 260, the User Mode Driver 240 may generate a framebuffer F2 according to the helmet information and the framebuffer F1. Because the resolution of the display device 112 is different from the resolution of the head-mounted display 120, in the embodiment, the Kernel Mode Driver 260 may transform the framebuffer F1 of the picture displayed on the display device 112 into the framebuffer F2 which is appropriate to the resolution of the head-mounted display 120. In an embodiment of the invention, the resolution of the display device 112 may be 1920×1080 (i.e. Aspect Ratio 16:9) or 800×600 (i.e. Aspect Ratio 4:3), and the resolution of the head-mounted display 120 may be 2880×1440, but the invention should not be limited thereto.

According to an embodiment of the invention, after the User Mode Driver 240 has generated the framebuffer F2, the User Mode Driver 240 may transmit the framebuffer F2 to the application layer (application program A1). That is to say, the application program A1 may directly obtain the framebuffer F2 which is appropriate to the resolution of the head-mounted display 120 from the User Mode Driver 240 without needing to obtain the framebuffer F2 which is appropriate to the resolution of the head-mounted display 120 from the DXGI Framework 230. Therefore, in the embodiment, the application program A1 is able to directly communicate with the User Mode Driver 240 without through the DXGI Framework 230, and as a result, the transmission time of the signals and instructions will be saved. Therefore, the serious picture-latency generated because of too many transmissions of the instructions and signals will be decreased.

According to an embodiment of the invention, after the application program A1 has obtain the framebuffer F2, the application program A1 may generate a left-eye picture and a right-eye picture that correspond to the head-mounted display 120 according to the framebuffer F2 and the pupil distance information of the user of the head-mounted display 120. Then, the left-eye picture and the right-eye picture that correspond to the head-mounted display 120 may be transmitted to the head-mounted display 120. When the head-mounted display 120 has obtained the left-eye picture and the right-eye picture, the head-mounted display 120 will display a VR picture according to the left-eye picture and the right-eye picture. Therefore, according to the embodiments of the invention, the head-mounted display 120 is able to display a VR picture corresponding to the D3D and OpenGL content.

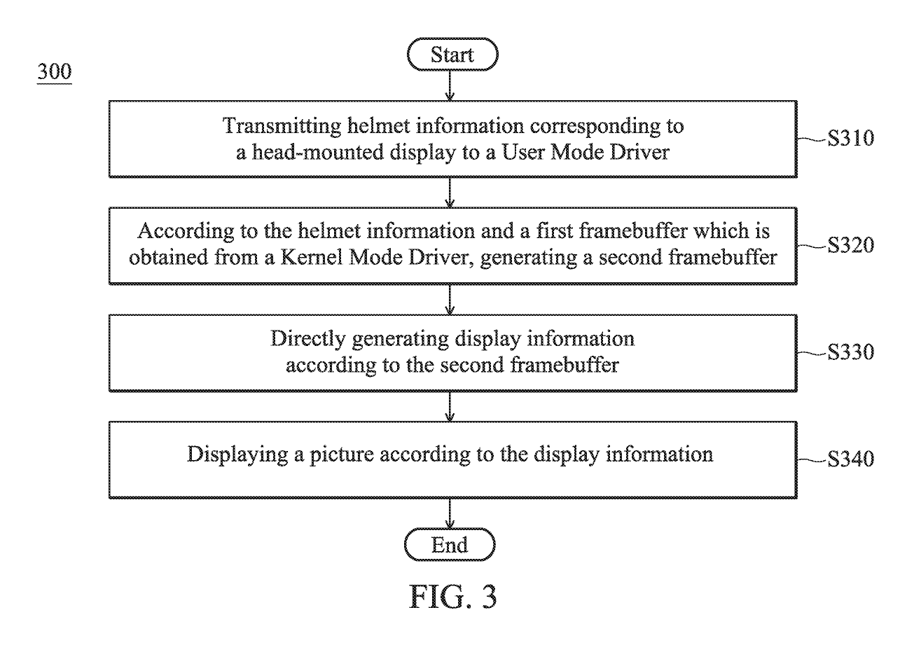

FIG. 3 is a flow chart 300 illustrating an image processing method according to an embodiment of the invention. The image processing method is applied to the image processing device 110. In step S310, helmet information corresponding to a head-mounted display is transmitted to the User Mode Driver. In step S320, a second framebuffer is generated according to the helmet information and a first framebuffer which is obtained from the Kernel Mode Driver. In step S330, display information (i.e. the left-eye picture and the right-eye picture corresponding to the head-mounted display) is directly generated according to the second framebuffer. In step S340, a picture is displayed on the head-mounted display according to the display information. According to an embodiment of the invention, the helmet information may be the resolution of the head-mounted display.

According to an embodiment of the invention, step S320 further comprises that the first framebuffer is transformed into the second framebuffer which is appropriate to the resolution of the head-mounted display according to the helmet information and the first framebuffer.

According to an embodiment of the invention, step S330 further comprises that a left-eye picture and a right-eye picture which correspond to the head-mounted display is generated according to the second framebuffer and the pupil distance information of the user of the head-mounted display.

According to the image processing method of the invention, the application program may directly obtain the picture (i.e. second framebuffer), which is appropriate to the resolution of the head-mounted display, from the User Mode Driver to display the VR picture corresponding to the D3D and OpenGL content through the head-mounted display. In addition, according to the image processing method of the invention, the head-mounted display will be able to support to directly display the D3D and OpenGL content. Therefore, the compatibility of the display contents of the head-mounted display is increased. Furthermore, according to the image processing method of the invention, unlike the conventional D3D and OpenGL content displaying technologies, the serious picture-latency that occurs because there are too many transmissions of instructions and signals can be decreased.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. Alternatively, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

Reference throughout this specification to “one embodiment” or “an embodiment” means that a particular feature, structure, or characteristic described in connection with the embodiment is included in at least one embodiment of the invention, but do not denote that they are present in every embodiment. Thus, the appearances of the phrases “in one embodiment” or “in an embodiment” in various places throughout this specification are not necessarily referring to the same embodiment of the invention.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An image processing system, comprising:
a head-mounted display; and
an image processing device, comprising:
a processor, transmitting helmet information corresponding to the head-mounted display to a User Mode Driver,
wherein according to the helmet information and a first framebuffer which is obtained from a Kernel Mode Driver, the User Mode Driver generates a second framebuffer, and
wherein the processor directly generates display information according to the second framebuffer, and the head-mounted display receives the display information and displays a picture according to the display information.

2. The image processing system of claim 1, wherein the helmet information comprises a resolution of the head-mounted display.

3. The image processing system of claim 2, wherein the first framebuffer is generated using the Direct3D and OpenGL technologies.

4. The image processing system of claim 2, wherein the User Mode Driver transforms the first framebuffer into the second framebuffer which is appropriate to the resolution of the head-mounted display according to the resolution and the first framebuffer.

5. The image processing system of claim 1, wherein the processor directly generates a left-eye picture and a right-eye picture which correspond to the head-mounted display according to the second framebuffer and pupil distance information of a user of the head-mounted display.

6. An image processing method, comprising:
transmitting helmet information corresponding to a head-mounted display to a User Mode Driver,
according to the helmet information and a first framebuffer which is obtained from a Kernel Mode Driver, generating a second framebuffer;
directly generating display information according to the second framebuffer; and
displaying a picture according to the display information.

7. The image processing method of claim 6, wherein the helmet information comprises a resolution of the head-mounted display.

8. The image processing method of claim 7, wherein the first framebuffer is generated using the Direct3D and OpenGL technologies.

9. The image processing method of claim 7, further comprising:
transforming the first framebuffer into the second framebuffer which is appropriate to the resolution of the head-mounted display according to the resolution and the first framebuffer.

10. The image processing method of claim 6, further comprising:
directly generating a left-eye picture and a right-eye picture which correspond to the head-mounted display according to the second framebuffer and pupil distance information of a user of the head-mounted display.
